(19) United States
(12) Patent Application Publication
(10) Pub. No.: US 2007/0100944 A1
(43) Pub. Date: May 3, 2007

(54) Uniform resource identifier decoration to enable connectivity for instant messaging providers serving non-authoritative namespaces

(75) Inventors: Peter S. Ford, Carnation, WA (US); Arnold N. Blinn, Bellevue, WA (US); Mark A. Gere, Woodinville, WA (US); Paul R. Ming, Bothell, WA (US); Shreedhar Madhavapeddi, Bellevue, WA (US); Kitty L. Leung, Redmond, WA (US); Ramesh Vyaghrapuri, Kenmore, WA (US)

Correspondence Address: VIERRA MAGEN/MICROSOFT CORPORATION, 575 MARKET STREET, SUITE 2500, SAN FRANCISCO, CA, 94105, US

(73) Assignee: Microsoft Corporation, Redmond, WA (US)

(21) Appl. No.: 11/261,052

(22) Filed: Oct. 28, 2005

(51) Int. Cl. G06F 15/16

(52) U.S. Cl. 709/206

(57) ABSTRACT

A technique for interconnecting users of different instant messaging services without requiring the users to change their account identifiers. A first user of a primary messaging service can communicate with a second user of a second, federated messaging service, where the first user is associated with a non-managed domain of the primary messaging service. When the first user sends a message to the second user, the primary messaging service decorates or modifies the first user's identifier as the sender so that the message, when received, appears to have come from a managed domain of the primary messaging service rather than from the non-managed domain. When a message from the second user is sent to the first user, the first user's identifier is undecorated in a reverse operation.

### BACKGROUND

Instant messaging (IM) applications have become increasingly popular as they allow users to exchange text messages using conventional mobile and stationary computing devices, such as PDAs, cell phones, laptop and desktop computers and the like. In addition to carrying human generated text, messaging applications can carry automatically generated text. For instance, an airline may use a messaging application to automatically communicate messages regarding flight status. Typically, an application running on the computing device allows the user to access a list of contacts to quickly initiate a messaging session with a selected friend, co-worker or other user. Each contact is associated with an identifier that allows the messaging infrastructure to route messages to the designated user. Additionally, the messaging application provides presence information to allow the user to determine which of the contacts are currently on-line.

However, a solution is needed for enabling users that are associated with different messaging services to communicate with one another. In particular, a solution is needed for a messaging service that supports users from both managed and non-managed domains in communicating with users of another messaging service.

### SUMMARY

The technology herein, roughly described, provides a technique for interconnecting users of different messaging services.

In an example implementation, a primary messaging service manages users in one or more associated managed domains. Additionally, non-managed users in one or more domains that are not managed by the primary messaging service can also use the primary messaging service. Furthermore, a second, federated messaging service, which is federated with the primary messaging service, manages users in one or more associated domains which are recognized by the primary messaging service as allied or trusted domains that retain their own administrative/management control. In the non-managed domains, there is no prearranged recognition or degree of trust by the primary messaging service. However, non-managed users can register with the primary messaging service to gain access, such as by using their account identifiers.

A mechanism is provided for routing messages between the non-managed user of the primary messaging service and the user of the second messaging service. If no such mechanism was provided, these users would not be able to communicate with one another. In one approach, when the non-managed user accesses the primary messaging service to send a message to the other user, the primary messaging service decorates or modifies the identifier of the non-managed user. In particular, the identifier, which is included with the message to identify the sender, is modified so that the message, when received by the recipient, appears to have come from a managed domain of the primary messaging service instead of from the non-managed domain. In a managed domain, there is a prearranged recognition or degree of trust by the primary messaging service.

Moreover, the user of the second messaging service can send a message to the non-managed user by including the original identifier of the non-managed user in the message. The message is undecorated by the primary messaging service to recover the non-managed user's original identifier, and subsequently forwarded to the non-managed user.

Furthermore, contacts may be maintained for the users in a manner that indicates whether decorating or undecorating is necessary when messaging with a particular user.

This summary is provided to introduce a selection of concepts in a simplified form that are further described below in the description. This summary is not intended to identify key features or essential features of the claimed subject matter, nor is it intended to be used as an aid in determining the scope of the claimed subject matter.

### BRIEF DESCRIPTION OF THE DRAWINGS

FIG. 1a illustrates a topology in which a primary messaging service interconnects with a second messaging service.

FIG. 1b illustrates a topology in which a primary messaging service interconnects second and third messaging services.

FIG. 2 illustrates a method by which a user logs in to a primary messaging service.

FIG. 3 illustrates a method by which a non-managed user of a primary messaging service adds a contact of a federated user of a second messaging service.

FIG. 4 illustrates a method by which a user of a second messaging service adds a contact of a non-managed user of a primary messaging service that supports the non-managed domain.

FIG. 5 illustrates a method by which a non-managed user of a primary messaging service user sends an instant message to a federated user of a second messaging service.

FIG. 6 illustrates a method by which a federated user of a second messaging service sends an instant message to a non-managed user of a primary messaging service.

FIG. 7 is a block diagram of computer hardware suitable for implementing embodiments of the invention.

### DETAILED DESCRIPTION

Instant messaging (IM) services are typically limited to interactions between users of a specific messaging service/network. When two different IM messaging services/networks interconnect, an issue arises with routing of messages between a non-network user and a network user. One approach is to create a new account for the non-network user that indicates the non-network user is using the primary IM network. However, when the IM interconnection uses Uniform Resource Identifier (URI)-based routing, using a new account can interfere with the routing process because the routing is based on the account identifier. This obstacle is overcome, in one possible approach, by decorating the account's member name with a term that will distinguish the member-name while making it possible to route messages over the Internet between primary and federated IM messaging services/networks. For example, the account user's original URI, e.g., username@domain1.com, can be modified to remove the ‘@’ sign and wrap the part of the URI after the ‘@’ sign, which is the domain name, within parenthesis or other demarcation characters, and finally append the primary network's domain name to the URI, e.g., to provide a URI such as: username(domainl.com) @primarydomain.com. This provides a clear indication of what network is being used while allowing proper routing of messages that are exchanged between the two networks.

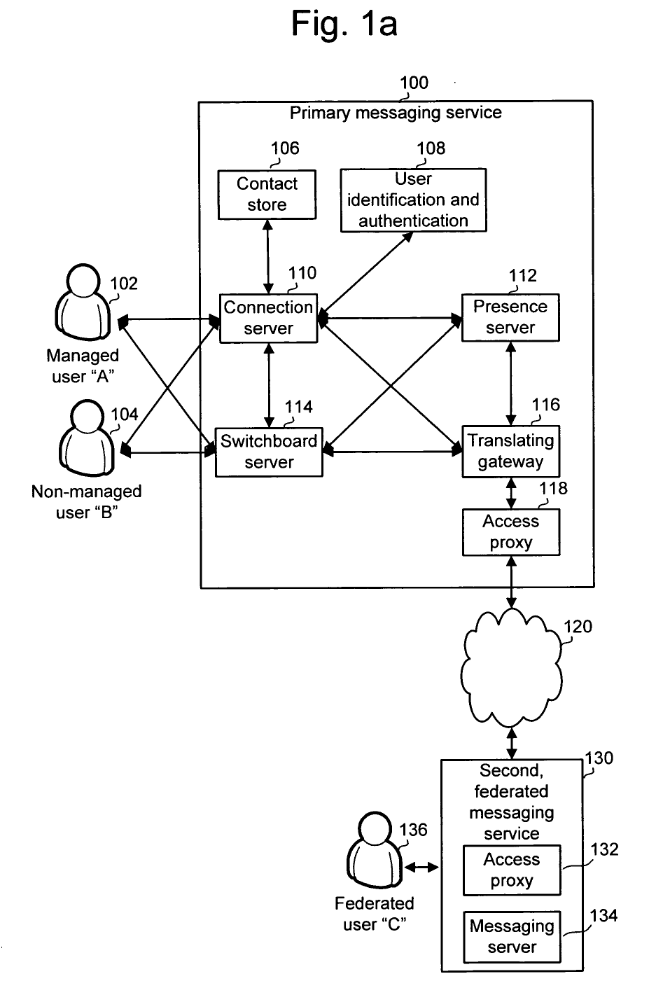

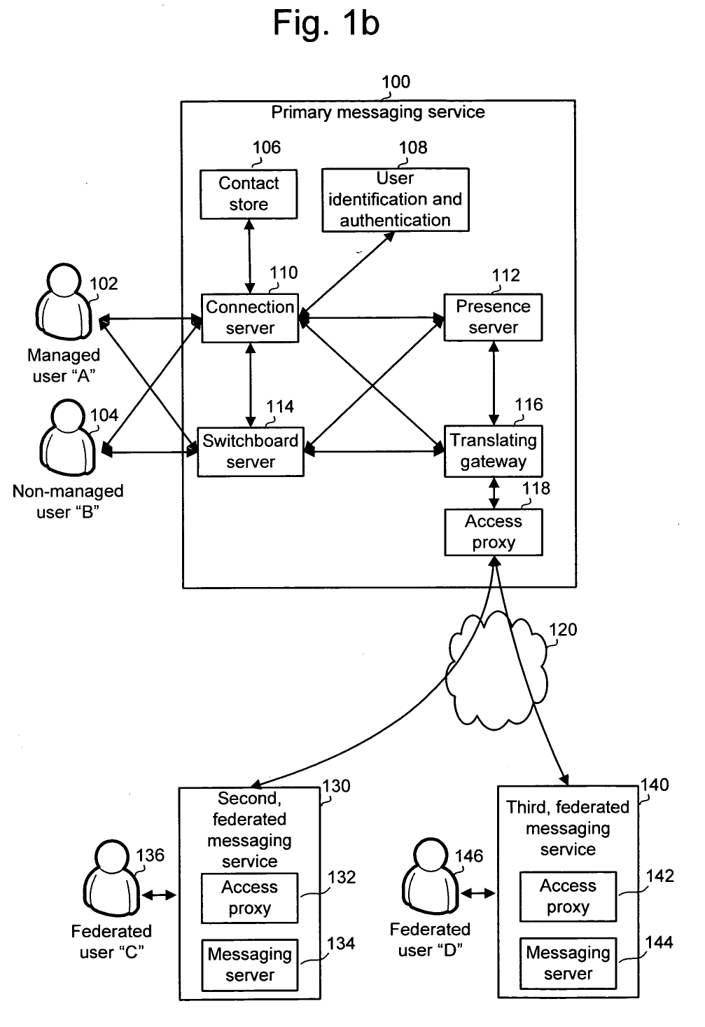

FIG. 1a illustrates a topology in which a primary messaging service interconnects with a second messaging service. In one possible implementation, a primary messaging service 100 interconnects a managed user “A” 102, e.g., a user of the primary messaging service 100 which is associated with a managed domain or namespace of the primary messaging service 100, a non-managed user “B” 104 of the primary messaging service 100, e.g., a user in a non-managed domain or namespace, that is, domain or namespace that is not managed by the primary messaging service 100, and a federated user “C” 136 of a second messaging service 130, e.g., a user in a federated domain or namespace of the second messaging service 130. The federated user “C” 136 is a managed user of the second messaging service 130. Note also that the primary messaging service 100 and the second messaging service 130 are federated with one another. Thus, the primary messaging service 100 is also a federated messaging service with respect to the second messaging service 130. The messaging services can be provide by any configuration of network and computing components, whether independent from one another or shared.

The term “user” may represent, e.g., a human user or an automated process on a client machine. The managed user “A” 102 represents an example user that is associated with a domain managed by the entity that manages the primary messaging service 100. For example, Microsoft Corporation provides the MSN®) Messenger messaging service and manages different user accounts in domains including “msn.com”, “hotmail.com” and “webtv.net”. Messaging between users in domains that are managed by the entity that manages the primary messaging service 100 does not typically require decorating or undecorating of identifiers since the primary messaging service 100 is the authoritative domain for these users and can control the routing of messages as desired.

The non-managed user “B” 104 represents an example user that is associated with a domain that is not managed by the entity that manages the primary messaging service 100. For example, the domains “aol.com”, “gmail.com” and “yahoo.com” are not currently managed by Microsoft Corporation, but are instead administered by separate entities. However, the non-managed users may register with the primary messaging service 100 to use the service. One example of a registration process is provided by Microsoft Corporation's .NET Passport Network, which allows users, including those in non-managed domains, to sign in to various online services, such as messaging and music download services, using their email address as the user name, together with a password. When the user registers with the primary messaging service 100 for the first time, the primary messaging service 100 can send a reply email which requires the user to respond to complete the registration. Subsequently, when the user logs in with the password, the primary messaging service 100 can verify the user's authenticity. It is also possible for the primary messaging service 100 to allow access to users with unverified e-mail addresses.

The federated user “C” 136 represents an example user that is associated with a domain that is federating with the entity that manages the primary messaging service 100. For example, the federated domain can be a domain that is recognized by the primary messaging service 100 as an allied or trusted domain. Federated domains or networks share some level of trust, but retain their own administrative/management control. For example, Microsoft's Live Communication Server (LCS) is an instant messaging server for enterprises such as corporations. The LCS provides messaging among the users of the enterprise. Messaging between the enterprise users and outside users, such as managed users and non-managed users of the primary messaging service, can go through the primary messaging service 100, in one approach.

The users may employ client machines of any type of computing device, including PDAs, cell phones, laptop and desktop computers. The client machines of the managed and non-managed users of the primary messaging service may run client-side software of a messaging application which allows the client to communicate with the primary messaging service 100 via a network such as the Internet or other wide-area network, for instance. The primary messaging service 100, in turn, runs server-side software of the messaging application. The federated users run client-side software of a separate messaging application, while the messaging server 134 in the federated messaging service 130 runs the server-side software of the separate messaging application. The messaging server 134 may be the LCS, in one example. The messaging application of the federated messaging service 130 may be configured to communicate with the primary messaging service 100 to exchange messages with users outside of the federated messaging service. To this end, an access proxy server 132 at the federated messaging service can communicate with a corresponding access proxy server 118 at the primary messaging service 100 via a network cloud 140 such as the Internet or other wide-area network, for instance.

The primary messaging service 100 includes a number of functions which may be provided on one or more computers such as servers, for instance. Moreover, multiple computers having the same function may be used for load balancing. The specific arrangement shown is provided as an example only. The primary messaging service 100 includes a connection server 110 with which the users “A” or “B” initially connect to access the primary messaging service. Optionally, a number of connection servers are used by the primary messaging service 100, and the user sends a login request to a dispatch server which assigns a connection server to log into. In the login process, the connection server 110 may relay the user's credentials, e.g., user/account name and password, to a user identification and authorization function 108 for verification. The user identification and authorization function 108 may compare the domain of the user to a list of managed domains to determine if there is a match, in which case the user is identified as a managed user. If there is no match, the user is identified, by default, as a non-managed user. Or, in another possible approach, the user identification and authorization function 108 maintains a list of non-managed domains. If there is a match with the user's domain, the user is identified as a non-managed user. The user identification and authorization function 102 thereby identifies the respective domains of managed and non-managed users which attempt to use the primary messaging service 100, and verifies that the users are authorized to gain access.

The contact store 106 is a storage location for the contacts of different users of the primary messaging service 100, such as users “A” and “B”. Contacts provide a shorthand way for users to select a recipient to send a message to. The client-side of the messaging application which runs on the client machine typically allows the user to assign shorthand identifiers or nicknames for the contacts, e.g., the text “Jim” may appear on the screen of the client machine in the list of contacts to refer to a user with the identifier “jsmith@acme.com”. The nicknames and full identifiers of the different contacts that a user has specified can therefore be stored in the contact store 106, indexed to the user, and downloaded to the user when the user logs in to the primary messaging service 100. Microsoft Corporation's MSN® Messenger is an example of a messaging application that provides such functionality.

Furthermore, presence information can be provided to enable a user to determine whether a particular contact is online. When a user logs in, the connection server 110 provides the user's contact list to the presence server 112, which determines the presence of each contact that is logged into the primary messaging service 100. Note that, in practice, there may be multiple presence servers associated with the contacts. For simplicity in FIG. 1a, only one presence server is shown. For a contact which identifies a federated user, the connection server 110 can communicate with the federated messaging service 130, via the translating gateway 116 and the access proxy 118, to obtain the presence information. The translating gateway 116 returns the presence information to the connection server 110 so that the presence information can be provided with the contact list to the user.

A switchboard server 114 is used to establish a messaging session between users by receiving and forwarding messages. In particular, when user “A” or “B” wishes to start an instant messaging conversation, the user sends a request to the connection server 110 which, in turn, sends a message to a switchboard server 114 requesting that a messaging session be opened. The connection server 110 can then provide the user “A” or “B” with information for joining the session, such as an IP address, port identifier and session cookie. For messages sent from the non-managed user “B” to the federated user “C”, the switchboard server 114 annotates the session to indicate that the incoming messages from the non-managed user “B” should be forwarded to the translating gateway 116 for decorating. In comparison, messages between user “B” and user “A” can be sent via the switchboard server 114 without using the translating gateway 116. In another approach, messages between users “A” and “B” go through the translating gateway 116 but do not require decoration.

The translating gateway 116 decorates and undecorates messages sent between non-managed users of the primary messaging service and federated users of the federated messaging service, in one particular implementation. For example, for a message sent from non-managed user “B” 104 to federated user “C” 136, the switchboard server 114 will receive the message and forward it to the translating gateway 116, where the sender's identifier is modified to make it appear as if the message originated from a managed domain of the primary messaging service 100 rather than from the non-managed domain. In an example implementation, the identifier of user “B” has the form “userB@networkB.com”, where “userB” is the user name in a user name field, and “networkB.com” is a domain name in a domain name field, e.g., according to the format: “username@domainname”. The recipient's identifier has the form “userC @networkC.com”. The translating gateway 116 decorates the sender's identifier by changing it to “userB(networkB.com)@networkA.com”, where “networkA.com” represents a managed domain of the primary messaging service 100, and forwards the message with the decorated identifier to the federated user “C” via the access proxies 118 and 132. In an alternative approach, the decoration of the message can include an explicit source route, such as a private route. In another approach, the functionality of the translating gateway 116 is incorporated into the switchboard server 114 so that the switchboard server performs the decorating and undecorating.

For a message sent from the federated user “C” to the non-managed user “B”, the translating gateway 116 undecorates the recipient's identifier. For example, the recipient's identifier may be “userB(networkB.com)@networkA.com”, while the sender's identifier is “userC@networkC.com”. In the decorated identifier, the domain of the recipient, “networkB.com”, is included in the user name field, along with the user name “userB”. One or more demarcation characters, such as parentheses, can be used to demarcate the user name from the domain name in the user name field. The translating gateway 116 undecorates the recipient's identifier by removing the recipient's domain name from the user name field and providing it in the domain name field in place of the domain name of the primary messaging service, resulting in the recipient identifier of “userB@networkB.com”. The translating gateway 116 forwards the message with the undecorated identifier to the switchboard server 114 for communication to the non-managed user “B”. Thus, the translating gateway 116 can determine that undecorating is to be performed when it recognizes that an incoming message from the federated messaging service 130 has a decorated identifier. In particular, the presence of the demarcation characters in the user identifier of the incoming message can signal that undecorating should be performed, e.g., when the demarcation characters are characters that are not recognized as valid characters for user names in the primary messaging service 100.

This approach is useful because the decorated identifier allows the message from the federated user to the non-managed user to be routed by the primary messaging service, while still conforming to Uniform Resource Identifier (URI) standards. Additionally, messages can be routed using conventional Internet protocols such as Session Initiation Protocol (SIP). If no such mechanism was provided, the federated user would attempt to communicate with the non-managed user outside the primary messaging service. However, when the non-managed user establishes a messaging session with the primary messaging service, reply messages from the federated user must also be handled by the primary messaging service. In the example provided above, the demarcation characters are parentheses. However, any suitable type of demarcation characters may be used, such as commas, semicolons and the like. For instance, according to RFC 3986, Uniform Resource Identifier (URI): Generic Syntax, January 2005, a reserved subset of characters that may be used to delimit syntax components within a URI includes the following sub-delimiters: “!”, “$”, “'”, “(“,”)”, “*”, “+”, “,”, “;” and “=”.

FIG. 1b illustrates a topology in which a primary messaging service interconnects second and third messaging services. In this approach, the primary messaging service 100 acts as an intermediate messaging service that allows users from two or more other messaging services to communicate with one another. In particular, a third federated messaging service 140, including an access proxy 142 and a messaging server 144, allows a user “D” 146 and the user “C” 136 to communicate with one another. The messaging service 130 and 140 may be independent of one another but federated with respect to the messaging service 100.

For example, a message sent from user “C” to user “D” travels via the primary messaging service 100. Assuming the identifier of user “D” has the form “userD@networkD.com”, a message initiated by user “C” may include the sender identifier of “userC@networkC.com” and the recipient identifier of “userD@networkD.com”. The message is received by the translating gateway 116 via the access proxy 118 and the sender identifier is decorated to “userC(networkC.com)@networkA.com”. The message forwarded to user “D” therefore has the decorated sender identifier and the recipient identifier of “userD@networkD.com”.

Note that typically the federated networks communicate with the primary messaging service via dedicated channels so that the primary messaging service knows the origin of their messages. Thus, it is not necessary for the recipient identifier in the message sent from the messaging service 130 to the messaging service 140, or vice-versa, to be decorated. Further, the translating gateway need not perform undecorating in such a case.

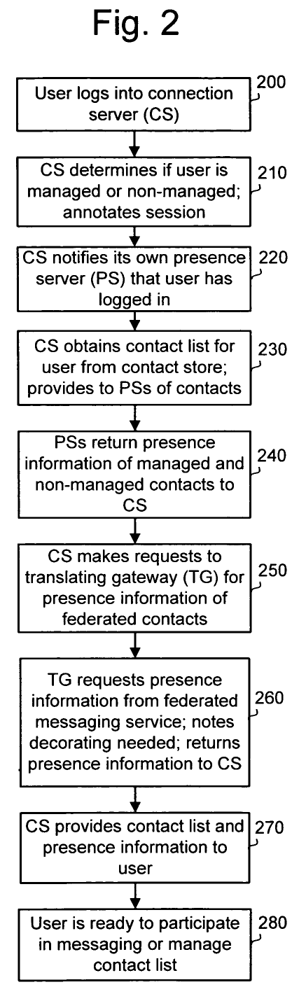

FIG. 2 illustrates a method by which a user logs in to a primary messaging service. Managed and non-managed users may log in to the primary messaging service 100 in different ways. Note that the federated users log into the messaging server 134 of the federated messaging service 130 which, in turn, communicates with the primary messaging service 100.

In one approach, the managed or non-managed user logs in to the connection server (CS) (step 200). Moreover, the login may occur manually or automatically, such as in response to launching a web browser. At step 210, the connection server can call the user identification and authentication function 108 to determine if the user is associated with a managed domain. If it is not, it can be concluded that the user is associated with a non-managed domain. The connection server annotates the messaging session accordingly. For example, the determination of whether the user is associated with a managed domain can involve comparing the domain name field of the user's identifier to a list of managed domain names. The managed domain names may include “msn.com”, “hotmail.com” and “webtv.com”, using the previous example in which Microsoft Corporation manages the primary messaging service 100. It is also possible to form a list which includes the non-managed and/or managed domains to identify users from these domains. For example, a list of non-managed domains can be updated as necessary each time a new non-managed user registers with the primary messaging service. Moreover, a list of managed domains can be updated when the primary messaging service registers a new managed domain.

At step 220, the connection server notifies its presence server (PS) that the user has logged in, so that the user's presence information can be updated. In practice, multiple presence servers can be used that maintain presence information for different contacts. Users are associated with a specific presence server but can choose to be connected to different connection servers. Once connected to a connection server, the user is associated with the connection server until they log out of the service. Any connection server can connect to any of the presence servers. At step 230, the connection server obtains the contact list for the user from the contact store and subscribes to the presence of each of the contacts by making a request to the contacts' respective presence servers. At step 240, the presence servers return the presence information for each managed and non-managed contact. At step 250, the connection server makes a request to the translating gateway for the presence information of the federated contacts, that is, the contacts that identify federated users. At step 260, the translating gateway requests presence information of the federated contacts from the federated messaging service and returns the presence information, when obtained, to the connection server. The translating gateway also notes that decorating should be performed for outgoing messages to the federated contact. At step 270, the connection server provides the contact list with the presence information for all contacts to the user. At step 280, the user is ready to participate in messaging or to manage the contact list, such as by adding or deleting contacts.

An analogous process can be performed at the federated messaging service to allow the federated user to log into the messaging server of the federated messaging service. In an example process, the federated user logs in to the messaging server 134, which verifies the user's identification, and notifies a local presence server that the user has logged in, so that the user's presence information can be updated. The messaging server obtains a contact list for the user from a local contact store and provides it to the local presence server, which in turn provides presence information for the contacts of the federated users. For contacts of managed or non-manages users of the primary messaging service 100, which are federated contacts relative to the federated messaging service 130, the messaging server can contact the primary messaging service 100 to obtain the presence information. The messaging server then provides the contact list with the presence information of all contacts to the federated user so that the federated user is able to participate in messaging or to manage the contact list such as by adding or deleting contacts.

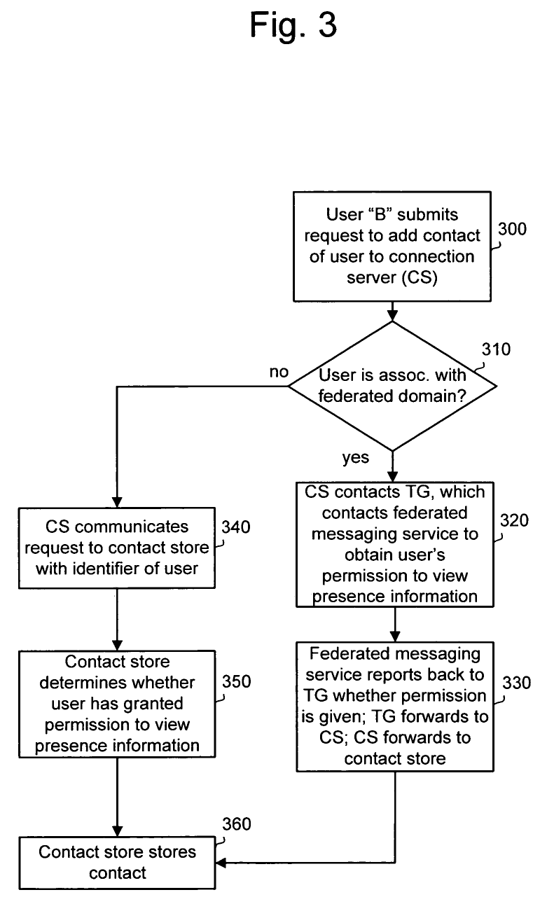

FIG. 3 illustrates a method by which a non-managed user of a primary messaging service adds a contact of a federated user of a second, federated messaging service. Generally, a user can interact with the messaging application on the client machine to manage the contacts. In the specific example provided, the non-managed user “B” submits a request to the connection server (CS) to add another user as a contact (step 300). The request includes the identifier of the user. For example, assume the user is user “C” with the identifier “userC@networkC.com”. At decision block 310, the connection server, accessing the user identification and authorization function 108, determines whether the user is associated with the federated domain. For example, the user identification and authorization function 108 can maintain a list of know federated domains, in addition to the list of managed domains mentioned previously. Thus, it can be concluded that a contact is for a federated user when the domain of the contact, e.g., “networkC.com”, appears in the list of federated domains. At step 320, the connection server contacts the translating gateway which, in turn, contacts the federated network to obtain the permission of user C to view its presence information. If user “C”'s allow list policy allows user “B” to view user “C”'s presence, then the federated messaging service will report back to the translating gateway which, in turn, reports back to the connection server which, in turn, reports back to the contact store (step 330).

Finally, at step 370, the contact store stores the contact and associated permission information. An indication that the contact is for a federated user may also be stored. This information may be used to configure a messaging session between the non-managed user and the federated user to indicate that messages should be sent via the translating gateway. Other information, such as a user-designated nickname for user “C”, may also be stored by the contact store 106, along with permissions that control, e.g., how user “B”'s presence information is used by user “C”. For example, user “B” may designate that user “C” should be blocked from receiving the presence information. User “B” is then ready to send a message to user “C” using the contact.

At decision block 310, if the user for which a contact is being added is not in the federated domain, the connection server communicates a request to the contact store with the identifier of the user (step 340). The request is to add the new contact. The contact store then determines whether the user has granted permission to view his or her presence information at step 340. At step 340, the contact store stores the contact and the associated permission information.

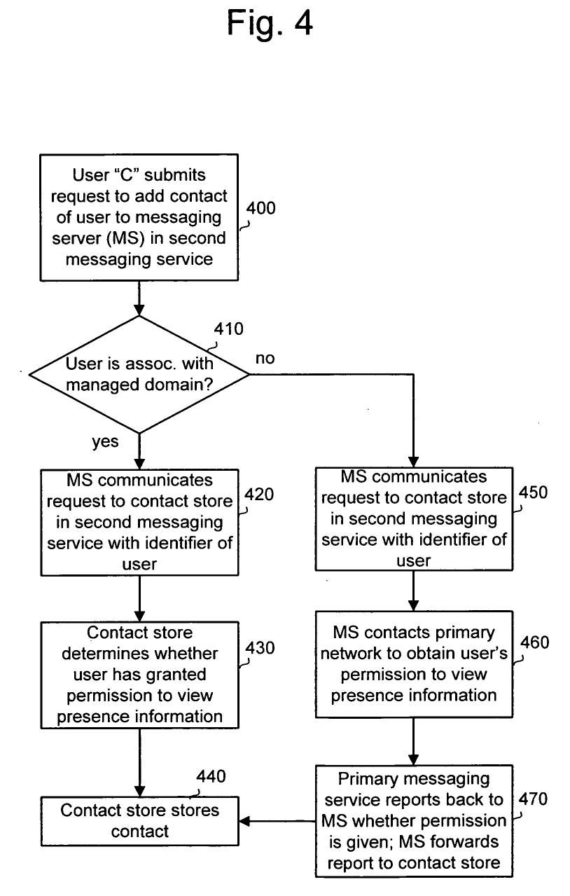

FIG. 4 illustrates a method by which a user of a second, federated messaging service adds a contact of a non-managed user of a primary messaging service that supports the non-managed domain. For example, at step 400, user “C” submits a request to add a contact of a user to the messaging server (MS) in the second messaging service. At decision block 410, the messaging server determines whether the user to be added is associated with a managed domain of the second messaging service. For example, the user may be identified as belonging to such a managed domain if the user's name matches a list of known users. If the user is associated with a managed domain of the second messaging service, at step 420, the messaging server communicates a request to add the contact to a local contact store in the second messaging service with the identifier of the user. At step 430, the contact store determines whether the user has granted permission for his or her presence information to be used and, at step 440, the contact store stores the contact and the permission information. The contact list on the user interface of user “C” is then updated with the new contact.

At decision block 410, if the user is not identified as being associated with a managed domain of the second messaging service, it can be concluded the user is associated with a managed or non-managed domain of the primary messaging service. At step 450, the messaging server communicates a request to a local contact store in the second messaging service with the identifier of the user. At step 460, the messaging server communicates with the primary messaging service to obtain the user's permission to view presence information. After accessing the necessary information in its contact store, the primary messaging service reports back regarding whether permission is granted, and this report is forwarded to the contact store of the federated messaging service (step 470). Next, at step 440, the contact store stores the contact and the permission information. The contact list on the user interface of user “C” is then updated with the new contact. Optionally, an indication such as an icon is displayed next to the contact entry for a managed or non-managed user of the primary messaging service to identify its status.

Generally, in the federated messaging service 130, the federated user can add the non-managed user “B” as a contact by using the decorated identifier of user “B”, e.g., “userB(networkB.com)@networkA.com”. Other information such as a user-designated nickname for user “B” may also be provided, along with permissions that control how user “C”'s presence information is used. Thus, the federated user can manually decorate the identifier of the non-managed user of the primary messaging service on the federated user's client machine using an appropriate user interface such as a keyboard. Although the decorated identifier has extra characters compared to the undecorated identifier, in the example provided, the syntax used is relatively intuitive and should not impose an undue burden on the federated user. In this approach, the decorated identifier is visible to the federated user but not to the non-managed user of the primary messaging service.

Optionally, appropriate software may be implemented by the messaging application at the federated messaging service 130 to avoid the need for the federated user to manually decorate the contact of the non-managed user, as discussed below. In this case, the identifier is automatically decorated when the contact is used. User “C” can therefore enter the undecorated identifier of user “B”, for instance, as “userB@networkB.com”. When user “C” selects the contact of user “B” to send a message, the messaging server at the federated messaging service, responsive to the flagging of the contact, decorates the recipient's identifier in the outgoing message. In this manner, the decoration is not seen by user “C” and there is no need for user “C” to manually decorate user “B”'s identifier when creating a contact. The flagged contact can also indicate to the messaging server at the federated messaging service that messages received from user “B” should be undecorated. Or, the presence of the demarcation characters in the sender's identifier of such messages can signal that undecorating should be performed, e.g., when the demarcation characters are characters that are not recognized as being part of a valid user name in the federated messaging service.

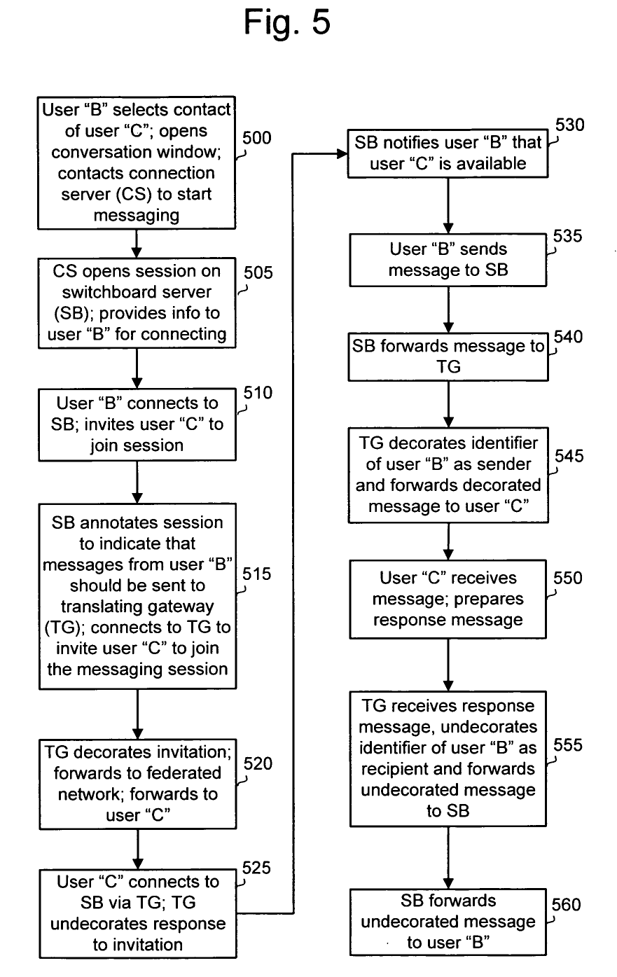

FIG. 5 illustrates a method by which a non-managed user of a primary messaging service sends an instant message to a federated user of a second, federated messaging service. After logging in to the messaging service, user “B” selects the contact of user “C” and opens a conversation window, for instance, using the client-side messaging software, and contacts the connection server (CS) to start messaging (step 500). The conversation window is a window in a user interface on the client machine of user “B” that allows the user to type in text, for instance. Various other input mechanisms may also be used. At step 505, the connection server opens a session on the switchboard server (SB) and provides information to the user “B” for connecting to the session, such as an IP address, port identifier and session cookie. At step 510, user “B” uses the information provided to connect to the switchboard, and invites user “C” to join the session. At step 515, the switchboard server annotates the session to indicate that messages from user “B” should be sent to the translating gateway, and connects to the translating gateway to invite user “C” to join the messaging session. At step 520, the translating gateway decorates user “B”'s identifier in the invitation and forwards the decorated invitation to the federated network which, in turn, forwards the decorated invitation to user “C”, e.g., via the access proxies 118 and 132 and the messaging server 134 at the federated messaging service 130. At step 525, user “C” indicates that he or she will accept the invitation to join the messaging session and connects to the switchboard server 114 via the translating gateway 116. The translating gateway undecorates the response to the invitation from user “C”. At step 530, the switchboard server notifies user “B” that user “C” is available for messaging.

step 535, user “B” composes and sends a message to user “C” via the switchboard server. At step 540, the switchboard server forwards the message to the translating gateway. At step 545, the translating gateway decorates the identifier of user “B” as the sender and forwards the decorated message, e.g., the message with the decorated identifier, to user “C”. At step 550, user “C” receives the message and prepares a response message. At step 555, the translating gateway receives the response message, undecorates the identifier of user “B” as the recipient, and forwards the undecorated message, e.g., the message with the undecorated identifier, to the switchboard server. Finally, at step 560, the switchboard server forwards the undecorated message to user “B”. Thus, in the example provided, the identifier of the non-managed user, user “B”, is decorated for messages sent from the non-managed user to the federated user, and undecorated for messages sent from the federated user to the non-managed user.

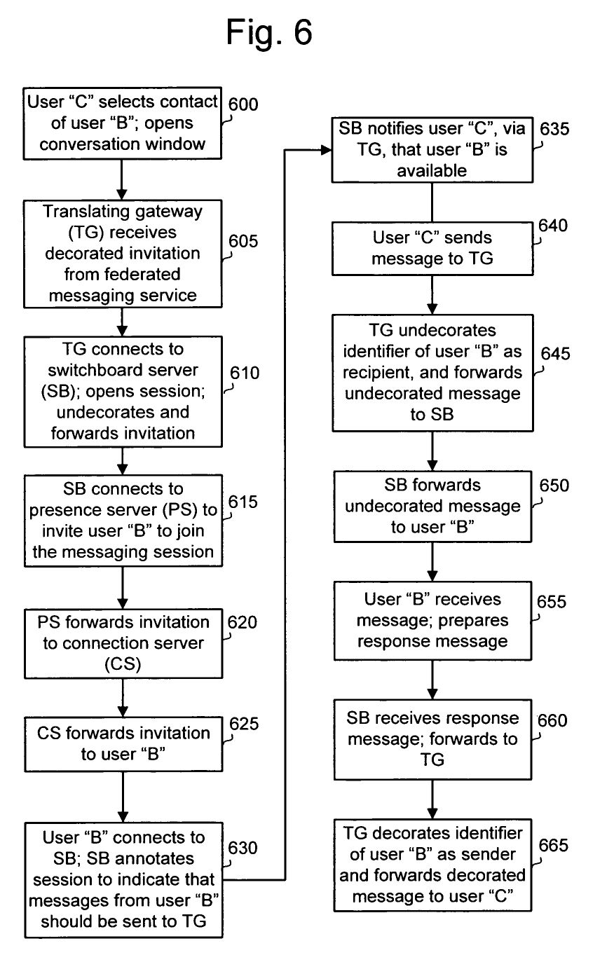

FIG. 6 illustrates a method by which a federated user of a second, federated messaging service sends an instant message to a non-managed user of a primary messaging service. After logging in to the messaging service, user “C” selects the contact of user “B” and opens a conversation window, for instance, using the client-side messaging software (step 600). The conversation window is a window in a user interface on the client machine of user “C” that allows the user to type in text, for instance. At step 605, the translating gateway receives a decorated invitation from the federated messaging service for user “B” to join the messaging session. At step 610, the translating gateway undecorates user “B”'s identifier in the invitation, connects to the switchboard server (SB), opens a session on the switchboard server, and forwards the undecorated invitation to the switchboard server. At step 615, the switchboard server connects to the presence server (PS) to invite user “B” to join the messaging session. At step 620, the presence server determines the location of user “B”, and relays the presence information and the invitation to the connection server. At step 625, the connection server forwards the invitation to user “B”. At step 630, user “B” accepts the invitation and connects to the switchboard server, e.g., using information provided by the connection server for connecting to the session, such as an IP address, port identifier and session cookie. The switchboard server annotates the session to indicate that messages from user “B” should be sent to the translating gateway.

step 635, the switchboard server notifies user “C”, via the translating gateway, that user “B” is available for messaging. At step 640, user “C” composes and sends a message to user “B” via the translating gateway. At step 645, the translating gateway undecorates the identifier of user “B” as the recipient and forwards the undecorated message to the switchboard server. At step 650, the switchboard server forwards the undecorated message to user “B”. At step 655, user “B” receives the message and prepares a response message. At step 660, the switchboard server receives the response message and forwards it to the translating gateway. At step 665, the translating gateway decorates the identifier of user “B” as the sender and forwards the decorated message to user “C”.

The technique provided is not limited to messaging between users in non-managed and federated domains. The technique may be used when interconnecting users in essentially any types of domains.

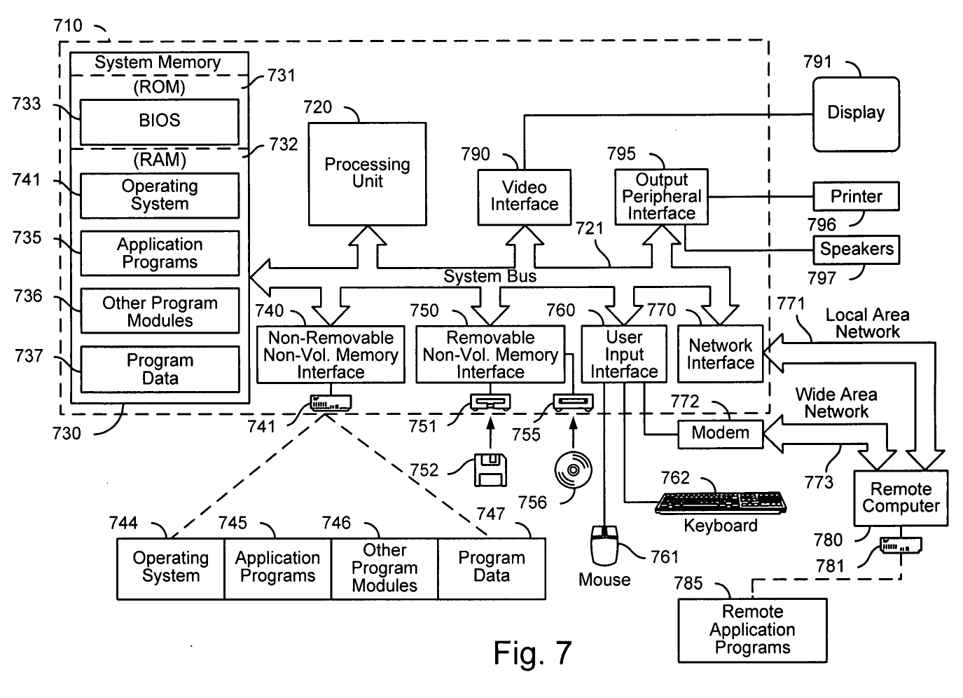

FIG. 7 is a block diagram of computer hardware suitable for implementing embodiments of the invention. An exemplary system for implementing the invention includes a general purpose computing device in the form of a computer 710. Components of computer 710 may include, but are not limited to, a processing unit 720, a system memory 730, and a system bus 721 that couples various system components including the system memory to the processing unit 720. The system bus 721 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 710 typically includes a variety of computer readable media. Computer readable media can be any available media that can be accessed by computer 710 and includes both volatile and nonvolatile media, removable and non-removable media. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 710. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above are also included within the scope of computer readable media.

The system memory 730 includes computer storage media in the form of volatile and/or nonvolatile memory such as read only memory (ROM) 731 and random access memory (RAM) 732. A basic input/output system 733 (BIOS), containing the basic routines that help to transfer information between elements within computer 710, such as during start-up, is typically stored in ROM 731. RAM 732 typically contains data and/or program modules that are immediately accessible to and/or presently being operated on by processing unit 720. By way of example, and not limitation, FIG. 7 illustrates operating system 734, application programs 735, other program modules 736, and program data 737.

The computer 710 may also include other removable/non-removable, volatile/nonvolatile computer storage media. By way of example only, FIG. 7 illustrates a hard disk drive 741 that reads from or writes to non-removable, nonvolatile magnetic media, a magnetic disk drive 751 that reads from or writes to a removable, nonvolatile magnetic disk 752, and an optical disk drive 755 that reads from or writes to a removable, nonvolatile optical disk 756 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 741 is typically connected to the system bus 721 through a non-removable memory interface such as interface 740, and magnetic disk drive 751 and optical disk drive 755 are typically connected to the system bus 721 by a removable memory interface, such as interface 750.

The drives and their associated computer storage media discussed above and illustrated in FIG. 7, provide storage of computer readable instructions, data structures, program modules and other data for the computer 710. For example, hard disk drive 741 is illustrated as storing operating system 744, application programs 745, other program modules 746, and program data 747. These components can either be the same as or different from operating system 734, application programs 735, other program modules 736, and program data 737. Operating system 744, application programs 745, other program modules 746, and program data 747 are given different numbers here to illustrate that, at a minimum, they are different copies. A user may enter commands and information into the computer 710 through input devices such as a keyboard 762 and pointing device 761, commonly referred to as a mouse, trackball or touch pad. Other input devices (not shown) may include a microphone, joystick, game pad, satellite dish, scanner, or the like. These and other input devices are often connected to the processing unit 720 through a user input interface 760 that is coupled to the system bus, but may be connected by other interface and bus structures, such as a parallel port, game port or a universal serial bus (USB). A monitor 791 or other type of display device is also connected to the system bus 721 via an interface, such as a video interface 790. In addition to the monitor, computers may also include other peripheral output devices such as speakers 797 and printer 796, which may be connected through an output peripheral interface 795.

The computer 710 may operate in a networked environment using logical connections to one or more remote computers, such as a remote computer 780. The remote computer 780 may be a personal computer, a server, a router, a network PC, a peer device or other common network node, and typically includes many or all of the elements described above relative to the computer 710, although only a memory storage device 781 has been illustrated. The logical connections depicted include a local area network (LAN) 771 and a wide area network (WAN) 773, but may also include other networks. Such networking environments are commonplace in offices, enterprise-wide computer networks, intranets and the Internet.

When used in a LAN networking environment, the computer 710 is connected to the LAN 771 through a network interface or adapter 770. When used in a WAN networking environment, the computer 710 typically includes a modem 772 or other means for establishing communications over the WAN 773, such as the Internet. The modem 772, which may be internal or external, may be connected to the system bus 721 via the user input interface 760, or other appropriate mechanism. In a networked environment, program modules depicted relative to the computer 710, or portions thereof, may be stored in the remote memory storage device. By way of example, and not limitation, FIG. 7 illustrates remote application programs 785 as residing on memory device 781. It will be appreciated that the network connections shown are exemplary and other means of establishing a communications link between the computers may be used.

The foregoing detailed description of the technology herein has been presented for purposes of illustration and description. It is not intended to be exhaustive or to limit the technology to the precise form disclosed. Many modifications and variations are possible in light of the above teaching. The described embodiments were chosen in order to best explain the principles of the technology and its practical application to thereby enable others skilled in the art to best utilize the technology in various embodiments and with various modifications as are suited to the particular use contemplated. It is intended that the scope of the technology be defined by the claims appended hereto.

We claim:

1. A computer-implemented method for messaging, comprising:
determining when a sending user of a first messaging service requests to send a message to a receiving user of a second messaging service, the sending user being associated with a first domain that is not managed by the primary messaging service;
forwarding the message to the receiving user with an identifier that indicates the sending user is associated with a second domain that is managed by the first messaging service rather than with the first domain.

2. The computer-implemented method of claim 1, wherein:
the message is forwarded with: (a) a domain name of the second domain in a domain name field, and (b) a user name of the sending user, and a domain name of the first domain, in a user name field.

3. The computer-implemented method of claim 2, wherein:
the user name field includes at least one demarcation character for separating the user name of the sending user from the domain name of the first domain.

4. The computer-implemented method of claim 2, wherein:
the domain name field and the user name field are part of a Uniform Resource Identifier.

5. The computer-implemented method of claim 1, wherein:
the receiving user is associated with a domain that is managed by the second messaging network.

6. The computer-implemented method of claim 1, wherein:
the first and second messaging services are federated with one another.

7. The computer-implemented method of claim 1, wherein:
the forwarding is performed at an intermediate messaging service.

8. The computer-implemented method of claim 1, further comprising:
determining when the sending user requests to send a second message to a second receiving user of the first messaging service;
forwarding the message to the second receiving user with an identifier that indicates the sending user is associated with the first domain.

9. The computer-implemented method of claim 1, further comprising:
annotating a messaging session of the sending user to indicate that the identifier should be modified to indicate that that the sending user is associated with the second domain rather than with the first domain.

10. A computer-implemented method for messaging, comprising:
determining when a first user of a first messaging service requests to add a contact of a second user of a second messaging service, the first user being associated with a first domain that is not managed by the first messaging service, the second user being associated with a second domain that is managed by the second messaging service;
adding the second user as the contact, and storing information indicating that, when the first user uses the contact to send a message to the second user, the message is to be forwarded to the second user with an identifier that indicates the first user is associated with a managed domain of the messaging service rather than with the first domain.

11. The computer-implemented method of claim 10, wherein:
the stored information indicates that: (a) a domain name of the managed domain is to be provided in a domain name field of the message, and (b) a user name of the first user, and a domain name of the first domain, are to be provided in a user name field of the message.

12. The computer-implemented method of claim 11, wherein:
the user name field includes at least one demarcation character for separating the user name of the first user from the domain name of the first domain.

13. The computer-implemented method of claim 10, wherein:
the first and second messaging services are federated with one another.

14. The computer-implemented method of claim 10, wherein:
the domain name field and the user name field are part of a Uniform Resource Identifier.

15. The computer-implemented method of claim 10, wherein:
the forwarding is performed at an intermediate messaging service.

16. Computer readable media having computer readable code embodied thereon for programming at least one processor to perform a method for messaging, the method comprising:
determining whether an identifier of a message transmitted to a receiving user of a first messaging service by a sending user of a second messaging service is decorated to include a domain name of a domain of the receiving user in a user name field; and
if the identifier is decorated, undecorating the identifier by removing the domain name from the user name field and providing the domain name in a domain name field of the identifier.

17. The computer readable media of claim 16, wherein:
the identifier includes a domain name of a domain that is managed by the first messaging service in the domain name field; and
the undecorating provides the domain name of the domain of the receiving user in the domain name field in place of the domain name of the managed domain.

18. The computer readable media of claim 16, wherein:
the domain of the receiving user is not managed by the first messaging service.

19. The computer readable media of claim 16, wherein:
the forwarding is performed at an intermediate messaging service.

20. The computer readable media of claim 16, wherein:
the determining determines that the identifier is decorated when at least one demarcation character is present in the user name field.
